(19) United States
(12) Patent Application Publication
(10) Pub. No.: US 2021/0261815 A1
(43) Pub. Date: Aug. 26, 2021

(54) MULTI-COMPONENT PREPARATION FOR USE AS A FLOOR COATING

(71) Applicant: Markus Hehenberger, Linz (AT)

(72) Inventor: Markus Hehenberger, Linz (AT)

(21) Appl. No.: 17/252,004

(22) PCT Filed: Jul. 1, 2019
(86) PCT No.: PCT/AT2019/060217

§ 371 Date: Dec. 14, 2020

(30) Foreign Application Priority Data
Jul. 6, 2018 (AT) A50584/2018

(51) Int. Cl. C09D 175/04; C09D 133/08; B05D 7/00; B05D 3/12

(52) U.S. Cl. CPC C09D 175/04; B05D 3/12; B05D 7/544; C09D 133/08

(57) ABSTRACT

A multi-component preparation for use as a floor coating, comprising as protective layer component and as top layer component at least one water-based polyurethane and/or polyacrylate resin dispersion and a matting agent, the protective layer component additionally comprising a ceramic additive, is described. In order to indicate such a multi-component preparation which can be walked on again quickly after application and has both high abrasion resistance and high solvent resistance, it is proposed that the protective layer component comprises a cross-linker, a catalyst for the crosslinking reaction, a dispersant and at least one defoaming agent for reducing the interfacial tensions, as well as a network former preventing the ceramic particles of the ceramic additive from settling and a metal-free thickener.

### TECHNICAL FIELD

The system described herein relates to a multi-component preparation for use as a floor coating.

### BACKGROUND OF THE INVENTION

Due to the increase in resistant bacterial strains, cleaning agents with a considerably higher proportion of aggressive organic solvents are increasingly being used in the area of health care facilities to clean the floors in these facilities. Therefore, there is a need for coatings or floor sealings which, in addition to a fundamentally desired abrasion resistance, should also have a high resistance to solvents, in particular a high resistance to disinfectants. The coated floor must be walkable again within a short period of time in order not to restrict the operation of the health and medical facilities.

It is known from the state of the art to apply a multi-component preparation for the coating and surface sealing of floors, which comprises a water-based polyurethane and/or polyacrylate resin dispersion as a protective layer and as a top layer component, the protective layer component also having a ceramic additive. The ceramic additive comprises alumina particles which, when the multi-component preparation applied to the floor has cured, partially protrude from the protective or top layer, thus increasing the abrasion resistance of the floor. The disadvantage is, however, that the protective or top layer of floors treated with such multi-component preparations is damaged by cleaning agents with high solvent contents and the coating subsequently loses its protective effect.

It is therefore desireable to have a multi-component preparation of the type described above, which can be walked on again quickly after application and exhibits both high abrasion resistance and high resistance to solvents.

### SUMMARY OF THE INVENTION

The system described herein provides a protective layer component that comprises a crosslinking agent, a catalyst for the crosslinking reaction, a dispersing agent, at least one defoaming agent as well as a network former preventing the ceramic particles of the ceramic additive from settling and a metal-free thickening agent.

As a result of the features according to the system described herein, on the one hand a higher crosslinking density is achieved at a high reaction rate. For example, isocyanates can be used as crosslinking agents and dibutyltin dilaurate, but also tin-free metal complex solutions can be used as catalysts for the crosslinking reaction. This ensures sufficient resistance even to aggressive cleaning agents with solvent contents of over 75%. In order to improve the storage stability as well as the wetting behavior of the multi-component preparation, additional measures may be taken due to the highly reactive crosslinkers or catalysts intended in the system described herein. The protective layer component according to the system described herein therefore contains a dispersing agent, for example a quaternary ammonium salt, to prevent premature crosslinking and at least one defoaming agent, for example a polyether siloxane copolymer emulsion or polysiloxane/polyglycol mixture containing pyrogenic silica, to stabilize foam-forming by-products occurring during the crosslinking reaction. The addition of such dispersing and defoaming agents causes a reduction and uniform distribution of interfacial tensions within the protective layer component, but the effect of ceramic particles suspended in the protective layer component and partially protruding from the surface, as known from the state of the art, cannot be achieved. Thickening agents, in particular metal-free associative thickeners for improving a settling-preventing effect, may not be used as a matter of principle, since such thickening agents may not be effective at reduced interfacial tensions in the component structure. Surprisingly, however, it has been shown that the addition of a polyamide-based network former, for example, with generally very weak settling-preventing properties, in combination with metal-free thickeners and, for example, pyrogenic silica-based matting agents, causes a partial protrusion of ceramic particles evenly distributed in the network without undesired particle agglomeration. This means that, despite a high crosslinking density, which is decisive for solvent resistance, the multi-component preparation according to the system described herein also achieves a high abrasion resistance due to the ceramic particles partially protruding from the applied floor coating.

### DESCRIPTION OF VARIOUS EMBODIMENTS

The system described herein uses a mass percentage of water-based polyurethane and/or polyacrylate resin dispersion of between 50% -80% in a protective layer component and 70% -85% in a top layer component. A ceramic additive may make up 15% -30% by mass of the protective layer component, whereby ceramic particles based on aluminum oxide, for example, may have a particle size between 21 μm and 30 μm. The dispersing agent can have a mass fraction of 0.1% -1%, the at least one defoaming agent a mass fraction of 0.5% -2%, the matting agent a mass fraction of 1% -3%, the network former a mass fraction of 0.2%-0.5% and the thickening agent a mass fraction of 0.5% -2%. In addition, both the protective layer component and the top layer component may each contain a levelling agent, for example based on fluorosilicone surfactants, with a mass fraction of 0.04% -0.1%. To further improve film forming behavior, co-solvents, e.g. based on glycol ether, can be added in a mass fraction of 0.25% -1.5% each.

In order to further increase the solvent resistance of the multi-component preparation while providing an abrasion resistant yet visually appealing coating, the top layer component may include a crosslinker, a catalyst for the crosslinking reaction, a dispersing agent, at least one defoaming agent, a thickener and a water-based wax dispersion. As a result, when the top layer component is applied to the protective layer formed by the protective layer component, the valleys formed between the ceramic particles protruding from the protective layer are filled in, while the tips of the protruding ceramic particles remain uncovered and thus also protrude from the top layer. As a result of these measures, on the one hand the abrasion resistance provided by the protective layer component can be maintained and on the other hand the solvent resistance can be further increased by the additional highly cross-linked top layer. Depending on the amount of wax dispersion added, the degree of gloss of the coating may be adjusted from matt to glossy without affecting the physical-chemical properties of the top layer component, resulting in a wide range of visually appealing coating variants. The mass portion of the wax dispersion can, for example, contain 2.5%-4.5% of the top layer component.

To enable the floor to be walked on or used again within a short period of time after the coating has been applied, and to achieve even greater solvent resistance, the water-based top layer component may include a solvent-free UV-crosslinkable polyurethane-acrylate copolymer dispersion or a solvent-free UV-crosslinkable polyester-polyurethane dispersion. This allows even higher degrees of crosslinking to be achieved, with the light-induced crosslinking or curing process being even faster than those based on air drying. The mass fraction can be 60%-80% of the top layer component.

Particularly favorable conditions in connection with a UV-crosslinkable top layer component may be obtained if the top layer contains a photoinitiator, a catalyst for the crosslinking reaction, a dispersing agent, a defoaming agent, a metal-free thickener and a water-based wax dispersion. The photoinitiators may be based on phenylglyoxylates, for example. In addition, a coalescing agent may be added to enable complete and phase-boundary-free fusion of the dispersion particles despite the faster light-induced crosslinking.

The system described herein also relates to a process for coating and surface sealing of floors with a multi-component preparation. In the process, the protective layer component and the top layer component may first be mixed separately by adding the cross-linking agent to the remaining components of the protective or top layer, respectively, via a stream while stirring continuously. The crosslinker may have a mass fraction of 10% of the protective layer component or the top layer component. After the crosslinker has been added, the protective or top layer component mixtures may be stirred further for between 3 and 5 minutes, e.g. with the aid of an electric stirrer. To form a protective layer, a quantity between 50 ml/m² and 80 ml/m², preferably 65 ml/m² of the protective layer component may be applied to a floor in lanes by a first person and then rolled by a second person crosswise to the direction of application. The coating application performed by the first person may be done, for example, using a T-bar. After the protective layer has cured at room temperature, a quantity of between 50 ml/m² and 80 ml/m², preferably 65 ml/m² of the top layer component may be applied to the cured protective layer to form a sealing top layer. The top layer is applied in the same way as the protective layer. Curing refers to air-curing as well as light-curing or heat-curing crosslinking and drying processes.

In order to avoid visual impairment of the coating on more porous floor coverings, such as wood, linoleum, rubber or mineral floors, which visual impairment is caused by the formation of haze or streaks due to the capillary action of the pores, it may be necessary to first sand and clean the uncoated floor, after which a pore-closing and adhesion-promoting primer may be applied to pre-treat the floor before the protective layer and top layer are formed.

### EXECUTION EXAMPLE

A multi-component preparation according to the system described herein may have a protective layer component with the following formulation:

| Ingredient | Mass fraction |
|---|---|
| quaternary ammonium salt (dispersing agent) | 0.525% |
| Dipropylene glycol monobutyl ether (co-solvent) | 0.475% |
| Glycol ether (co-solvent) | 0.525% |
| Ceramic additive with aluminum oxide particles at a | 17.5% |
| particle size between 21 μm and 30 μm | |
| water-based polyurethane resin dispersion incl. | 59.172% |
| isocyanate as crosslinker | |
| pyrogenic silica-based matting agent | 1.2% |
| Dibutyltin dilaurate with 10% TPM (catalyst) | 0.059% |
| Polyethersiloxane copolymer emulsion (defoaming agent) | 1.1% |
| Polysiloxane/polyglycol mixture (defoaming agent) | 1.17% |
| Fluorosilicone surfactant (levelling agent) | 0.06% |
| non-ionic polyurethane associative thickener (metal-free | 1.425% |
| thickener) | |
| Polyamide-based wax solution (network former) | 0.34% |
| Water | 16.449% |

A top layer component may have the following formulation:

| Ingredient | Mass fraction |
|---|---|
| quaternary ammonium salt (dispersing agent) | 0.475% |
| Glycol ether (co-solvent) | 1.1% |
| water-based polyurethane resin dispersion incl. | 79.8% |
| isocyanate as crosslinker | |
| pyrogenic silica-based matting agent | 1.44% |
| Polyethylene wax dispersion | 3.115% |
| Dibutyltin dilaurate with 10% TPM (catalyst) | 0.055% |
| Polyethersiloxane copolymer emulsion (defoaming agent) | 0.9% |
| Polysiloxane/polyglycol mixture (defoaming agent) | 1.8% |
| Fluorosilicone surfactant (levelling agent) | 0.09% |
| non-ionic polyurethane associative thickener (metal-free | 1.2% |
| thickener) | |
| Water | 10.025% |

A UV-curable top layer component may have the following formulation:

| Ingredient | Mass fraction |
|---|---|
| quaternary ammonium salt (dispersing agent) | 0.4% |
| solvent-free UV-crosslinkable polyurethane resin | 80% |
| dispersion | |
| pyrogenic silica-based matting agent | 2% |
| Polyethylene wax dispersion | 7% |
| Zinc complex in n-butyl acetate solution (catalyst) | 0.1% |
| Polysiloxane copolymer emulsion (defoaming agent) | 2% |
| Phenylglyoxylate based photoinitiator | 1.25% |
| non-volatile coalescing agent | 1.5% |
| non-ionic polyurethane associative thickener (metal-free | 1.25% |
| thickener) | |
| Water | 4.5% |

In order to prepare a multi-component preparation according to the system described herein, the protective layer component and the top layer component may first be mixed separately by adding an isocyanate solution to the remaining components of the protective or top layer via a thin stream while stirring continuously. The isocyanate solution may contain a mass fraction of 10% of the protective or top layer component. After the isocyanate has been added, the protective or top layer component mixtures may be stirred further for between 3 and 5 minutes, e.g. with the aid of an electric stirrer. In case of a UV-crosslinkable top layer component, a photoinitiator may be added instead of the isocyanate.

To prepare the floor, the floor may first be sanded and cleaned, after which a pore-clogging and adhesion-promoting primer, for example also based on a polyurethane and/or polyacrylate resin dispersion, may be applied to pre-treat the floor.

To form a protective layer, a quantity of 65 ml/m² of the protective layer component may be applied to the floor evenly and in strips by a first person and then rolled by a second person at right angles to the direction of application. The coating application carried out by the first person may be done, for example, by means of a T-bar or with a rubber or metal slider. After the protective layer has cured at room temperature, a quantity of 65 ml/m² of the top layer component may be applied to the protective layer to form a sealing top layer, after which the protective layer also cures. In the case of a UV-curable top layer, the curing process may be carried out using a manually operated UV unit, for example.

The system described herein is not restricted to the described embodiments. It may be varied within the scope of the claims, taking into account the knowledge of the relevant person skilled in the art. Other embodiments of the system described herein will be apparent to those skilled in the art from a consideration of the specification and/or an attempt to put into practice the system described herein. It is intended that the specification and examples be considered as illustrative only, with the true scope and spirit of the invention being indicated by the following claims.

1. A multi-component preparation for use as a floor coating, comprising:
a protective layer component and as a top layer component, having at least one water-based polyurethane and/or polyacrylate resin dispersion and a matting agent, a ceramic additive, a crosslinker, a catalyst for the crosslinking reaction, a dispersing agent, at least one defoaming agent for reducing the interfacial tensions, and a network former preventing the ceramic particles of the ceramic additive from settling and a metal-free thickener; and
a top layer component having at least one water-based polyurethane and/or polyacrylate resin dispersion and a matting agent.

2. The multi-component preparation according to claim 1, wherein the top layer component includes a crosslinking agent, a catalyst for the crosslinking reaction, a dispersing agent and at least one defoaming agent for reducing the interfacial tensions, a metal-free thickening agent and a water-based wax dispersion.

3. The multi-component preparation according to claim 1, wherein the water-based top layer component includes a solvent-free UV-crosslinkable polyurethane-acrylate copolymer dispersion or a solvent-free UV-crosslinable polyester-polyurethane dispersion.

4. The multi-component preparation according to claim 3, wherein the top layer component includes a photoinitiator, a catalyst for the crosslinking reaction, a dispersing agent and a defoaming agent for reducing the interfacial tensions, a coalescing agent, a metal-free thickening agent and a water-based wax dispersion.

5. A method for coating and surface sealing floors with a multi-component preparation according to claim 1, comprising:
forming a protective layer by applying an amount between 50 ml/m² and 80 ml/m² of the protective layer component to a floor in webs;
rolling the protective layer component transversely to a direction of application;
after the protective layer cures at room temperature forming a sealing top layer by applying an amount e4 between 50 ml/m² and 80 ml/m²of the top layer component to the protective layer in webs; and
rolling the top layer component transversely to a direction of application, after which the top layer cures.

6. A method for coating and surface sealing of floors according to claim 5, further comprising:
sanding and cleaning a floor before forming the protective layer and the top layer; and
applying a pore-closing and adhesion-promoting primer for pretreatment of the floor after sanding and cleaning and before forming the protective layer and the top layer.

7. A method for coating and surface sealing of floors according to claim 5, wherein 65 ml/m² of the protective layer component and 65 ml/m² of the top layer component is applied.

8. A method for coating and surface sealing floors with a multi-component preparation according to claim 2, comprising:
forming a protective layer by applying an amount between 50 ml/m² and 80 ml/m² of the protective layer component to a floor in webs;
rolling the protective layer component transversely to a direction of application;
after the protective layer cures at room temperature, forming a sealing top layer by applying an amount between 50 ml/m² and 80 ml/m² of the top layer component to the protective layer in webs; and
rolling the top layer component transversely to a direction of application, after which the top layer cures.

9. A method for coating and surface sealing of floors according to claim 8, further comprising:
sanding and cleaning a floor before forming the protective layer and the top layer; and
applying a pore-closing and adhesion-promoting primer for pretreatment of the floor after sanding and cleaning and before forming the protective layer and the top layer.

10. A method for coating and surface sealing of floors according to claim 8, wherein 65 ml/m² of the protective layer component and 65 ml/m² of the top layer component is applied.

11. A method for coating and surface sealing floors with a multi-component preparation according to claim 3, comprising:
forming a protective layer by applying an amount between 50 ml/m² and 80 ml/m² of the protective layer component to a floor in webs;
rolling the protective layer component transversely to a direction of application;
after the protective layer cures at room temperature, forming a sealing top layer by applying an amount between 50 ml/m² and 80 ml/m² of the top layer component to the protective layer in webs; and
rolling the top layer component transversely to a direction of application, after which the top layer cures.

12. A method for coating and surface sealing of floors according to claim 11, further comprising:
sanding and cleaning a floor before forming the protective layer and the top layer; and
applying a pore-closing and adhesion-promoting primer for pretreatment of the floor after sanding and cleaning and before forming the protective layer and the top layer.

13. A method for coating and surface sealing of floors according to claim 11, wherein 65 ml/m² of the protective layer component and 65 ml/m² of the top layer component is applied.

14. A method for coating and surface sealing floors with a multi-component preparation according to claim 4, comprising:
forming a protective layer by applying an amount between 50 ml/m² and 80 ml/m² of the protective layer component to a floor in webs;
rolling the protective layer component transversely to a direction of application;
after the protective layer cures at room temperature, forming a sealing top layer by applying an amount between 50 ml/m² and 80 ml/m² of the top layer component to the protective layer in webs; and
rolling the top layer component transversely to a direction of application, after which the top layer cures.

15. A method for coating and surface sealing of floors according to claim 14, further comprising:
sanding and cleaning a floor before forming the protective layer and the top layer; and
applying a pore-closing and adhesion-promoting primer for pretreatment of the floor after sanding and cleaning and before forming the protective layer and the top layer.

16. A method for coating and surface sealing of floors according to claim 14, wherein 65 ml/m² of the protective layer component and 65 ml/m² of the top layer component is applied.
